(19) United States
(12) Patent Application Publication
(10) Pub. No.: US 2019/0299786 A1
(43) Pub. Date: Oct. 3, 2019

(54) VEHICLE BRAKING SYSTEM

(71) Applicant: ADVICS CO., LTD., Kariya-shi, Aichi-ken (JP)

(72) Inventors: Yusuke Nakagawa, Kariya-shi, Aichi-ken (JP); Takayuki Yamamoto, Nagakute-shi, Aichi-ken (JP)

(73) Assignee: ADVICS CO., LTD., Kariya-shi, Aichi-ken (JP)

(21) Appl. No.: 16/465,730

(22) PCT Filed: Dec. 5, 2017
(86) PCT No.: PCT/JP2017/043561

§ 371 Date: May 31, 2019

(30) Foreign Application Priority Data
Dec. 5, 2016 (JP) 2016-235809

(51) Int. Cl. B60L 3/00; B60T 8/171; B60T 8/1761; B60T 8/96

(52) U.S. Cl. CPC B60L 3/0076; B60T 8/96; B60T 8/1761; B60T 8/171

(57) ABSTRACT

A vehicle braking system is provided with: a driving motor that can apply a regenerative braking force to a wheel; a friction braking device that is operated so as to apply a friction braking force to the wheel; and a braking control device. The braking control device controls the friction braking device on the basis of the detected value of a wheel speed when the detected value of the wheel speed of the wheel based on an output signal from each of wheel speed sensors SE5-SE8 can be acquired, and, when the detected value of the wheel speed cannot be acquired, acquires the estimated value of the wheel speed of the wheel on the basis of the rotational speed of the driving motor and controls the friction braking device on the basis of the estimated value of the wheel speed.

### TECHNICAL FIELD

The present invention relates to a vehicle braking system including a regenerative device that applies regenerative braking force to wheels, a friction braking device that operates to apply friction braking force to wheels, and a control device that controls the regenerative device and the friction braking device.

### BACKGROUND ART

At the time of vehicle braking, a slip amount is calculated based on a detected value of a wheel speed calculated based on an output signal from a wheel speed sensor, and when the slip amount becomes greater than or equal to a threshold value, determination can be made that the slip has occurred at a wheel and hence an antilock brake control is started. During the implementation of the antilock brake control, the friction braking force to be applied to the wheel is controlled based on the fluctuation in the slip amount of the wheel.

When an abnormality occurs in the wheel speed sensor or an abnormality occurs in a calculating unit for calculating the detected value of the wheel speed based on the output signal from the wheel speed sensor, the detected value of the wheel speed cannot be acquired. When the detected value of the wheel speed cannot be acquired as described above, the implementation of the antilock brake control is prohibited as described in, for example, Patent literature 1.

### CITATIONS LIST

### Patent Literature

Patent Literature 1: Japanese Unexamined Patent Application Publication No. 52-115987

### SUMMARY OF INVENTION

### Technical Problems

In recent years, development of a vehicle having an automatic travel function is being advanced. In such a vehicle, even when the detected value of the wheel speed cannot be obtained and the implementation of the antilock brake control is prohibited, the automatic travel may be performed. Then, when a braking force is applied to the vehicle during automatic traveling under a situation where the execution of the antilock brake control is prohibited, a slip occurs at the wheel of the vehicle and the lowering in the stability of the vehicle behavior may not be suppressed.

The above problems may occur even when shifting from automatic traveling to non-automatic traveling which is traveling by the driver's vehicle operation. During the automatic traveling, the vehicle system is the main control of vehicle traveling, and the driver is the subordinate. When shifting from automatic traveling to non-automatic traveling, a failsafe becomes necessary so that the stability of the vehicle behavior can be ensured on the vehicle system side during the shifting period until the driver, who is the subordinate, can sufficiently secure the control of the vehicle traveling.

Furthermore, the above problems may occur even at the time of vehicle braking during non-automatic traveling. That is, when a slip has occurred at the wheel during the driver's vehicle operation under a situation where the detected value of the wheel speed cannot be acquired, the lowering in the stability of the vehicle behavior may not be suppressed as the antilock brake control is not executed.

An object of the present invention is to provide a vehicle braking system capable of suppressing lowering in stability of a vehicle behavior at the time of vehicle braking under a situation where a detected value of a wheel speed cannot be acquired.

### Solutions to Problems

A vehicle braking system for overcoming the above problems assumes a system including: a regenerative device that applies a regenerative braking force to a wheel; a friction braking device operable to apply friction braking force to the wheel; and a control device that controls the regenerative device and the friction braking device based on a required braking force that is a braking force to be applied to a vehicle, where a wheel speed sensor that outputs a wheel speed signal related to a rotational speed of the wheel is electrically connected to the control device. In the vehicle braking system, the control device adjusts the friction braking force to be applied to the wheel by operating the friction braking device based on a detected value of the wheel speed when a detected value of the wheel speed based on the wheel speed signal is acquirable, and adjusts the friction braking force to be applied to the wheel by acquiring an estimated value of a wheel speed of the wheel based on a rotational speed of a power generator of the regenerative device, and operating the friction braking device based on the estimated value of the wheel speed when the detected value of the wheel speed based on the wheel speed signal is not acquirable.

According to the configuration described above, when the control device can acquire the detected value of the wheel speed of the wheel, the friction braking force to be applied to the wheel can be adjusted by controlling the friction braking device based on the detected value of the wheel speed.

Since there is a correlation between the wheel speed of the wheel to which regenerative braking force can be applied and the rotational speed of the power generator of the regenerative device, the wheel speed of the relevant wheel can be estimated based on the rotational speed of the power generator. Thus, in the configuration described above, when the control device cannot acquire the detected value of the wheel speed of the wheel, the control device acquires the estimated value of the wheel speed of the wheel based on the rotational speed of the power generator. The friction braking force to be applied to the wheel can be adjusted by controlling the friction braking device based on the estimated value of the wheel speed. Therefore, even at the time of vehicle braking in a situation where the detected value of the wheel speed cannot be acquired, the lowering in the stability of the vehicle behavior can be suppressed by controlling the friction braking device based on the estimated value of the wheel speed.

### BRIEF DESCRIPTION OF DRAWINGS

FIG. 1 is a configuration view showing an outline of a vehicle including a vehicle braking system according to an embodiment.

FIG. 2 is a configuration view showing a fluid pressure generation device and a braking actuator of the vehicle braking system.

FIG. 3 is a configuration view showing the braking actuator.

FIG. 4 is a flowchart describing a processing routine executed by a first ECU configuring the vehicle braking system, the processing routine being executed to apply friction braking force to each wheel by operation of a friction braking device.

FIG. 5 is a flowchart describing a processing routine executed by the first ECU to diagnose whether or not an abnormality has occurred in a second ECU, and to calculate the wheel speeds of the wheels and the vehicle body speed of the vehicle.

FIG. 6 is a flowchart describing a processing routine executed by the first ECU to perform a first slip suppression control when a slip has occurred at the drive wheel.

FIG. 7 is a flowchart describing a processing routine executed by a second ECU to perform an antilock brake control or a second slip suppression control when a slip has occurred at the wheel.

### DESCRIPTION OF EMBODIMENTS

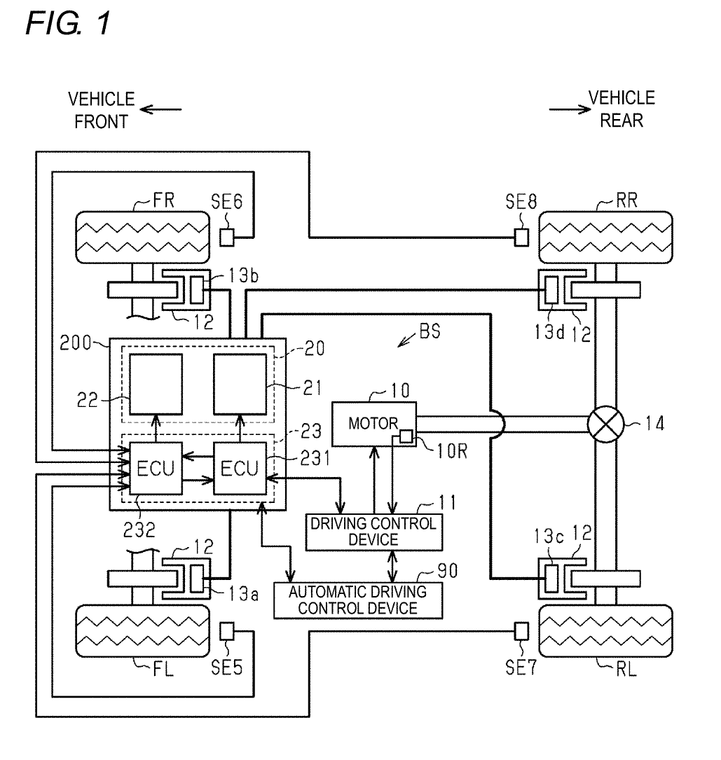

Hereinafter, one embodiment of a vehicle braking system will be described with reference to FIGS. 1 to 7.

FIG. 1 schematically shows a vehicle including a vehicle braking system BS according to the present embodiment. As shown in FIG. 1, the vehicle includes a driving motor 10, which is an example of a driving source of the vehicle, and a driving control device 11 that controls the drive of the driving motor 10. Furthermore, a braking mechanism 12 is individually provided with respect to each wheel FL, FR, RL, and RR in the vehicle. Each of these braking mechanisms 12 has a wheel cylinder 13a, 13b, 13c, and 13d, respectively, and a friction braking force corresponding to a WC pressure Pwc, which is the fluid pressure in the wheel cylinder 13a to 13d, can be applied to each wheel FL, FR, RL, and RR, respectively.

The driving system of the vehicle is rear wheel drive, and the driving force output from the driving motor 10 is transmitted to the rear wheels RL and RR through a differential gear 14. Furthermore, in the vehicle, a regenerative braking force BPR can be applied to the rear wheels RL, RR by controlling the driving motor 10 and an inverter for the driving motor 10. Therefore, in the present embodiment, the driving motor 10 and the driving control device 11 constitute an example of a “regenerative device” capable of applying the regenerative braking force BPR to the rear wheels RL and RR. The driving motor 10 and the driving control device 11 constituting an example of the regenerative device are also components of the braking system BS.

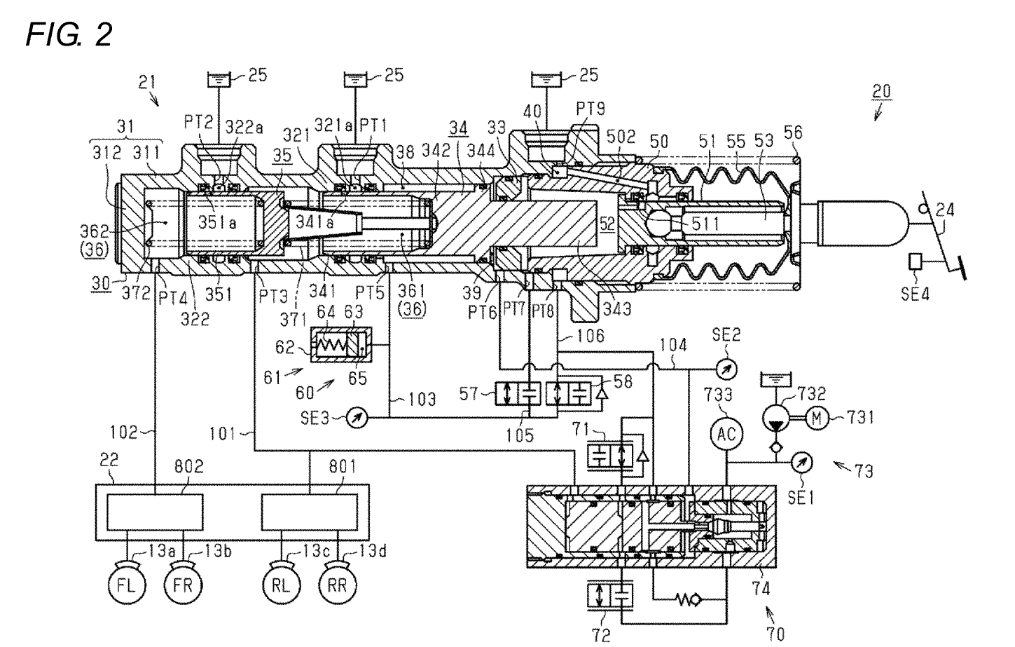

The vehicle is provided with a friction braking unit 200 that controls the adjustment of the WC pressure Pwc in each of the wheel cylinders 13a to 13d. The friction braking unit 200 is a component of the braking system BS. The friction braking unit 200 is provided with a friction braking device 20. As shown in FIGS. 1 and 2, the friction braking device 20 includes a fluid pressure generation device 21 to which a braking operation member 24 such as a brake pedal is drivingly connected and a braking actuator 22 provided separately from the fluid pressure generation device 21. The fluid pressure generation device 21 and the braking actuator 22 are controlled by a braking control device 23. The WC pressure Pwc in all the wheel cylinders 13a to 13d can be adjusted by operating the fluid pressure generation device 21 by the braking control device 23. Furthermore, although description will be made in detail later, the braking actuator 22 is configured to be able to individually adjust the WC pressure Pwc in each of the wheel cylinders 13a to 13d.

When applying the braking force to the vehicle, the braking control device 23 may cooperate with the driving control device 11. Specifically, the braking control device 23 transmits, to the driving control device 11, a required braking force BPT which is a braking force to be applied to the vehicle. The driving control device 11 that received the required braking force BPT controls the driving motor 10 (and inverter circuit) so that the regenerative braking force BPR is applied to the rear wheels RL and RR within the range not exceeding the required braking force BPT. When the regenerative braking force BPR is applied to the rear wheels RL and RR, the driving control device 11 transmits the magnitude of the regenerative braking force BPR applied to the rear wheels RL and RR to the braking control device 23. The braking control device 23 is configured to control the friction braking device 20 based on a difference obtained by subtracting the regenerative braking force BPR from the required braking force BPT. That is, in the braking control device 23, the friction braking device 20, the driving motor 10, and the friction braking unit 200 are controlled so that the sum of the regenerative braking force BPR applied to the rear wheels RL, RR and the friction braking force BPP to apply to the rear wheels RL, RR becomes equal to the required braking force on the rear wheels RL, RR. Thus, the WC pressure Pwc of at least one of the wheel cylinders 13a to 13d is increased, and the friction braking force BPP is applied to the wheel corresponding to such wheel cylinder.

Next, the fluid pressure generation device 21 of the friction braking device 20 will be described with reference to FIG. 2. FIG. 2 shows a state in which the braking operation member 24 is operated by the driver. Here, as shown in FIG. 2, the configuration of the fluid pressure generation device 21 will be described with the left side in the figure as the front side and the right side in the figure as the rear side.

As shown in FIG. 2, the fluid pressure generation device 21 includes a master cylinder 30, a reaction force generation device 60, and a servo pressure generation device 70 which is an example of an operating unit.

### <Master Cylinder 30>

The master cylinder 30 is connected to the braking actuator 22 through pipes 101 and 102. The master cylinder 30 includes a bottomed substantially cylindrical main cylinder 31 in which the front side is closed and the rear side is opened, a substantially cylindrical cover cylinder 50 disposed on the rear side of the main cylinder 31, and a boot 55 disposed on the rear side of the cover cylinder 50.

The main cylinder 31 is provided with two small diameter portions 321 and 322 in the form of inward flanges. Of the small diameter portions 321 and 322, the first small diameter portion 321 is disposed on the rear side, and the second small diameter portion 322 is disposed on the front side. Annular communication spaces 321a and 322a are respectively formed over the entire periphery on the inner peripheral surfaces of the small diameter portions 321 and 322. In the interior of the main cylinder 31, a circular ring shaped inner wall member 33 is provided on the rear side of the first small diameter portion 321, where the outer peripheral surface of the inner wall member 33 is brought into surface contact with an inner peripheral surface of a peripheral wall 311 of the main cylinder 31.

Furthermore, a first master piston 34 is provided inside the main cylinder 31, and a master chamber 36 is formed by the first master piston 34, the peripheral wall 311 of the main cylinder 31, and a bottom wall 312. In the present embodiment, a second master piston 35 is disposed between the bottom wall 312 of the main cylinder 31 and the first master piston 34. Therefore, the master chamber 36 is divided into two master chambers 361 and 362 by the second master piston 35. Of the two master chambers 361 and 362, the first master chamber 361 is disposed on the rear side, and the second master chamber 362 is disposed on the front side of the first master chamber 361. A first master spring 371 in which the front end is supported by the second master piston 35 and the rear end is supported by the first master piston 34 is accommodated in the first master chamber 361. Furthermore, a second master spring 372 in which the front end is supported by the bottom wall 312 of the main cylinder 31 and the rear end is supported by the second master piston 35 is accommodated in the second master chamber 362.

The second master piston 35 has a bottomed substantially cylindrical shape in which the rear side is closed and the front side is opened, and is slidable toward the front side and the rear side (i.e., left and right direction in the figure) along the inner peripheral surface of the second small diameter portion 322. A second communication path 351a that communicates the communication space 322a formed in the second small diameter portion 322 and the inner side of a tubular portion 351, that is, the second master chamber 362 is provided on the upper side in the figure in the tubular portion 351 of the second master piston 35. The communication between the communication space 322a and the second master chamber 362 through the second communication path 351a is maintained while the second master piston 35 is located at the initial position, that is, the position when the braking operation member 24 is not operated. On the other hand, the communication is blocked when the second master piston 35 moves toward the front side of the initial position as shown in FIG. 2.

The first master piston 34 includes a tubular portion 341 having a substantially cylindrical shape, a main body portion 342 having a substantially circular column shape connected to a rear end of the tubular portion 341, a projection 343 that projects out from the main body portion 342 toward the rear side, and an annular flange portion 344 provided at a rear end portion of the main body portion 342. The tubular portion 341 is slidable toward the front side and the rear side (i.e., left and right direction in the figure) along the inner peripheral surface of the first small diameter portion 321, where an outer diameter of the tubular portion 341 is equal to the diameter of the main body portion 342. Furthermore, the flange portion 344 is slidable toward the front side and the rear side (i.e., left and right direction in the figure) along the inner peripheral surface of a portion between the first small diameter portion 321 and the inner wall member 33 in the peripheral wall 311 of the main cylinder 31. Therefore, an annular first fluid pressure chamber 38 is partitioned and formed on the outer peripheral side of the first master piston 34 between the flange portion 344 and the first small diameter portion 321.

A first communication path 341a that communicates the communication space 321a formed in the first small diameter portion 321 and the inner side of the tubular portion 341, that is, the first master chamber 361 is provided on the upper side in the figure in the tubular portion 341 of the first master piston 34. The communication between the communication space 321a and the first master chamber 361 through the first communication path 341a is maintained while the first master piston 34 is located at the initial position, that is, the position when the braking operation member 24 is not operated. On the other hand, the communication is blocked when the first master piston 34 moves toward the front side of the initial position as shown in FIG. 2.

The projection 343 of the first master piston 34 is slidable toward the front side and the rear side (i.e., left and right direction in the figure) with respect to the inner peripheral surface of the inner wall member 33, and the rear end of the projection 343 is located between the inner wall member 33 and the rear end of the peripheral wall 311 of the main cylinder 31. Furthermore, an annular servo chamber 39 is partitioned and formed on the outer peripheral side of the projection 343 between the flange portion 344 and the inner wall member 33.

The cover cylinder 50 is connected to the rear end portion of the main cylinder 31. Specifically, the front end portion of the cover cylinder 50 is located slightly on the rear side than the inner wall member 33 in the main cylinder 31, while the rear end portion of the cover cylinder 50 is located on the rear side than the main cylinder 31. An annular space 40 having an annular shape is partitioned and formed between the outer peripheral surface of the cover cylinder 50 and the inner peripheral surface of the peripheral wall 311 of the main cylinder 31.

Furthermore, the opening on the rear side of the cover cylinder 50 is closed by the input piston 51. A second fluid pressure chamber 52 is partitioned and formed on the inner side of the cover cylinder 50 by the inner wall member 33, the projection 343 of the first master piston 34, and the input piston 51. The operation of the braking operation member 24 by the driver is input to the input piston 51 through an operation rod 53. In other words, when the amount of braking operation by the driver increases, the input piston 51 moves toward the front side by being pushed by the operation rod 53.

The cover cylinder 50 is provided with a cover side passage 502 connected to an annular space 40 formed on the outer peripheral side thereof. The cover side passage 502 is opened to a portion of the inner peripheral surface of the cover cylinder 50 that is in sliding contact with the input piston 51. Furthermore, the input piston 51 is provided with an input side passage 511 in communication with the second fluid pressure chamber 52. The input side passage 511 is opened to a portion of the outer peripheral surface of the input piston 51 that is in sliding contact with the inner peripheral surface of the cover cylinder 50. Then, when the braking operation member 24 is not operated, the input side passage 511 is connected to the cover side passage 502, and the annular space 40 is in communication with the second fluid pressure chamber 52. On the other hand, when the braking operation member 24 is operated and the input piston 51 moves toward the front side, the communication between the input side passage 511 and the cover side passage 502, that is, the communication between the annular space 40 and the second fluid pressure chamber 52 is released as shown in FIG. 2.

The boot 55 is disposed on the outer peripheral side of the input piston 51. Specifically, the front end of the boot 55 is supported by the cover cylinder 50, and the rear end of the boot 55 is supported by the operation rod 53. The operation rod 53 is biased toward the rear side by a compression spring 56 disposed on the outer peripheral side of the boot 55.

Next, a plurality of ports provided on the peripheral wall 311 of the main cylinder 31 will be described.

As shown in FIG. 2, on the upper side in the figure of the peripheral wall 311 of the main cylinder 31, a port PT1 communicating the communication space 321a of the first small diameter portion 321 and the outside of the master cylinder 30, and a port PT2 communicating the communication space 322a of the second small diameter portion 322 and the outside of the master cylinder 30 are provided. The two ports PT1 and PT2 are connected to an atmospheric pressure reservoir 25. Therefore, when the master pistons 34 and 35 are respectively disposed at the initial position, the master chambers 361 and 362 are communicated with the atmospheric pressure reservoir 25. On the other hand, when the master pistons 34 and 35 move toward the front side from the initial position, respectively, the communication between the master chambers 361 and 362 and the atmospheric pressure reservoir 25 is released as shown in FIG. 2 and the MC pressure Pmc which is the fluid pressure in each of the master chambers 361, 362 increases.

Furthermore, on the lower side in the figure of the peripheral wall 311 of the main cylinder 31, a first discharge port PT3 communicating the first master chamber 361 and the outside of the master cylinder 30, and a second discharge port PT4 communicating the second master chamber 362 and the outside of the master cylinder 30 are provided. The second discharge port PT4 is connected to a second fluid pressure circuit 802 of the braking actuator 22 through the pipe 102. Furthermore, the first discharge port PT3 is connected to both the first fluid pressure circuit 801 of the braking actuator 22 and the servo pressure generation device 70 through the pipe 101. The communication between the braking actuator 22 and the master chambers 361 and 362 through the discharge ports PT3 and PT4 is maintained regardless of the positions of the master pistons 34 and 35.

Furthermore, a port PT5 is provided on the slightly rear side of the first small diameter portion 321 to communicate the first fluid pressure chamber 38 and the outside. The port PT5 is connected to the reaction force generation device 60 through a reaction force pipe 103. Furthermore, a servo port PT6 is provided on the rear side of the port PT5 to communicate the servo chamber 39 and the outside. The servo port PT6 is connected to the servo pressure generation device 70 through a pipe 104.

Furthermore, a port PT7 is provided on the rear side of the servo port PT6 to communicate the second fluid pressure chamber 52 and the outside. The first pipe 105 is connected to the port PT7. One end (upper end in the drawing) of the first pipe 105 is connected to the port PT7, and the other end (lower end in the drawing) of the first pipe 105 is connected to the reaction force pipe 103. The first pipe 105 is provided with a first control valve 57 which is a normally closed electromagnetic valve.

Furthermore, a port PT8 is provided on the rear side of the port PT7 to communicate the annular space 40 and the outside. The second pipe 106 is connected to the port PT8. One end (upper end in the drawing) of the second pipe 106 is connected to the port PT8, and the other end (lower end in the drawing) of the second pipe 106 is connected to the reaction force pipe 103. The second pipe 106 is provided with a second control valve 58 which is a normally opened electromagnetic valve.

Furthermore, a port PT9 for communicating the annular space 40 with the atmospheric pressure reservoir 25 is provided at the same position of the port PT8 in the left and right direction in the drawing, that is, on the upper side of the port PT8.

### <Reaction Force Generation Device 60>

As shown in FIG. 2, the reaction force generation device 60 includes a stroke simulator 61. The stroke simulator 61 includes a simulator cylinder 62 and a simulator piston 63 that divides the interior of the simulator cylinder 62 into two spaces. Of the two spaces, a simulator spring 64 that biases the simulator piston 63 toward the rear side is provided in a space on the front side of the simulator piston 63. Furthermore, the space 65 on the rear side of the simulator piston 63 communicates with the reaction force pipe 103.

### <Servo Pressure Generation Device 70>

As shown in FIG. 2, the servo pressure generation device 70 includes a pressure reducing valve 71, a pressure increasing valve 72, a high pressure supply unit 73, and a mechanical regulator 74. The pressure reducing valve 71 is a normally opened linear electromagnetic valve, and the pressure increasing valve 72 is a normally closed linear electromagnetic valve.

The high pressure supply unit 73 includes a servo pump 732 having a servo motor 731 as a driving source, an accumulator 733 that accumulates high-pressure brake fluid, and an accumulator pressure detection sensor SE1 that detects an accumulator pressure which is a fluid pressure in the accumulator 733. Then, when the accumulator pressure detected by the accumulator pressure detection sensor SE1 becomes less than a predetermined pressure, the brake fluid is supplied from the servo pump 732 to the accumulator 733 by the drive of the servo motor 731 and the accumulator pressure is increased. The high pressure brake fluid accumulated in the accumulator 733 is supplied to the regulator 74.

<Operation of Friction Braking Device 20 when Increasing MC Pressure Pmc in Each Master Chamber 361, 362>

The linear mode and the REG mode are prepared as operation modes for operating the friction braking device 20.

In the linear mode, the braking control device 23 opens the first control valve 57 and closes the second control valve 58. Thus, the first fluid pressure chamber 38 and the second fluid pressure chamber 52 are communicated with each other in the master cylinder 30, and the communication between the first fluid pressure chamber 38 and the atmospheric pressure reservoir 25 in the master cylinder 30 is released. Then, the servo pressure Psv which is the fluid pressure in the servo chamber 39 in the master cylinder 30 is controlled by controlling the drive of the pressure reducing valve 71 and the pressure increasing valve 72 of the servo pressure generation device 70 in such a state. That is, when the servo pressure Psv is increased by the drive of the pressure reducing valve 71 and the pressure increasing valve 72, both the first master piston 34 and the second master piston 35 move toward the front side. As a result, the communication between the atmospheric pressure reservoir 25 and each of the master chambers 361 and 362 is released, and the MC pressure Pmc in each master chamber 361 and 362 is increased.

On the other hand, when the servo pressure Psv is reduced by the drive of the pressure reducing valve 71 and the pressure increasing valve 72, both the first master piston 34 and the second master piston 35 move toward the rear side. As a result, the MC pressure Pmc in each master chamber 361 and 362 is reduced.

The opening degree of the pressure reducing valve 71 and the opening degree of the pressure increasing valve 72 are individually controlled according to the operation of the braking operation member 24 by the driver. Therefore, the MC pressure Pmc in each of the master chambers 361 and 362 can be adjusted by the driver's braking operation. Furthermore, in the present embodiment, the MC pressure Pmc in each master chamber 361, 362 can be adjusted by controlling the pressure reducing valve 71 and the pressure increasing valve 72 even at the time of vehicle braking that does not involve driver's braking operation (e.g., at the time of automatic brake).

In the REG mode, both the first control valve 57 and the pressure increasing valve 72 are closed by the braking control device 23, and both the second control valve 58 and the pressure reducing valve 71 are opened. When the braking operation member 24 is operated in such a state, in the master cylinder 30, the input piston 51 moves toward the front side, and the communication between the second fluid pressure chamber 52 and the atmospheric pressure reservoir 25 is released. Then, when the input piston 51 is further moved toward the front side by the driver's braking operation, the first master piston 34 is biased by the increase in the fluid pressure in the second fluid pressure chamber 52, the first master piston 34 and the second master piston 35 are moved toward the front side, and the MC pressure Pmc in each of the master chambers 361 and 362 is increased. At this time, although the volume of the servo chamber 39 in the master cylinder 30 is expanded, the brake fluid is replenished into the servo chamber 39 from the regulator 74 of the servo pressure generation device 70.

### <Braking Actuator 22>

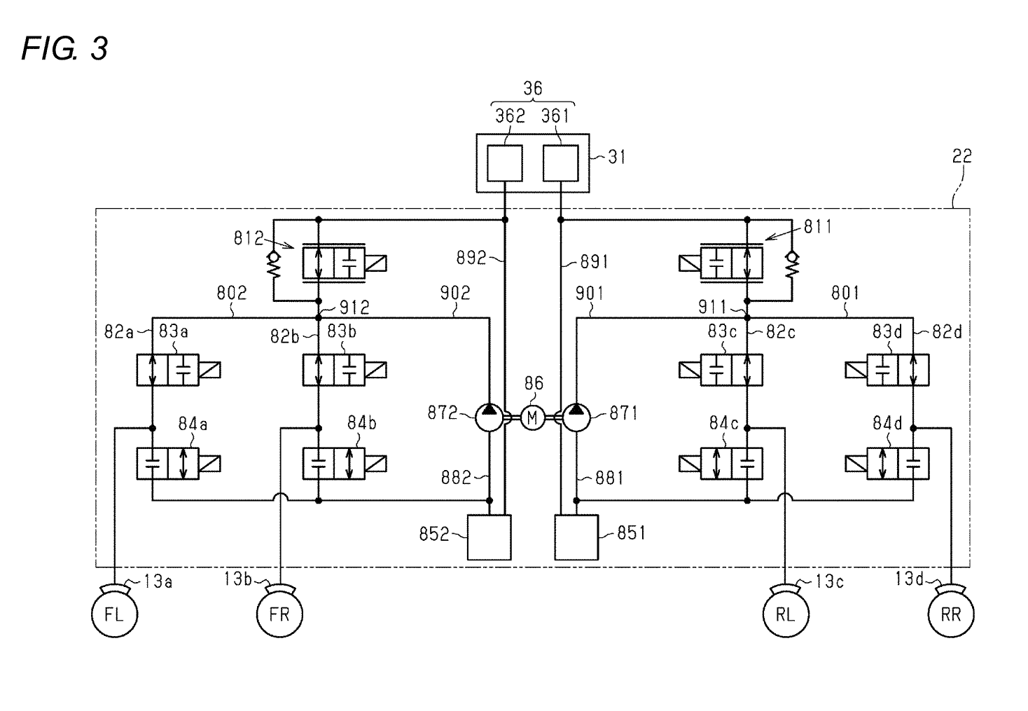

As shown in FIG. 3, the braking actuator 22 includes two systems of fluid pressure circuits 801 and 802. The wheel cylinder 13c for the left rear wheel and the wheel cylinder 13d for the right rear wheel are connected to the first fluid pressure circuit 801. The wheel cylinder 13a for the left front wheel and the wheel cylinder 13b for the right front wheel are connected to the second fluid pressure circuit 802. When the brake fluid flows into the first and second fluid pressure circuits 801 and 802 from the master chambers 361 and 362 of the fluid pressure generation device 21, the brake fluid is supplied to the wheel cylinders 13a to 13d.

In fluid path connecting the master cylinder 30 and the wheel cylinders 13a to 13d in the fluid pressure circuits 801 and 802, differential pressure adjustment valves 811 and 812, which are linear electromagnetic valves, are provided. A path 82c for the left rear wheel and a path 82d for the right rear wheel are provided on the wheel cylinders 13c and 13d side than the differential pressure adjustment valve 811 in the first fluid pressure circuit 801. Similarly, a path 82a for the left front wheel and a path 82b for the right front wheel are provided on the wheel cylinders 13a and 13b side than the differential pressure adjustment valve 812 in the second fluid pressure circuit 802. Then, in the paths 82a to 82d, holding valves 83a, 83b, 83c, and 83d, which are normally opened Electromagnetic valves that are closed when restricting the pressure increase of the WC pressure Pwc, and pressure reducing valves 84a, 84b, 84c and 84d, which are normally closed electromagnetic valves that are opened when pressure reducing the WC pressure Pwc are provided.

The reservoirs 851 and 852 for temporarily storing the brake fluid that has flowed out from the wheel cylinders 13a to 13d through the pressure reducing valves 84a to 84d, and pumps 871, 872 that are operated based on the drive of the pump motor 86 are connected to the first and second fluid pressure circuits 801 and 802. The reservoirs 851 and 852 are connected to the pumps 871 and 872 through suction flow paths 881 and 882, and are connected to a passage on the master cylinder 30 side than the differential pressure adjustment valves 811 and 812 through the master side flow paths 891 and 892. The pumps 871 and 872 are connected to connection portions 911 and 912 between the differential pressure adjustment valves 811 and 812 and the holding valves 83a to 83d through the supply flow paths 901 and 902, respectively.

When the pump motor 86 is driven, the pumps 871 and 872 draw the brake fluid from the reservoirs 851 and 852 and the master chambers 361 and 362 of the master cylinder through the suction flow paths 881 and 882 and the master side flow paths 891 and 892, respectively, and eject the brake fluid into the supply flow paths 901 and 902.

### <Detection System>

As shown in FIG. 2, in addition to the accumulator pressure detection sensor SE1, a servo pressure sensor SE2, a fluid pressure chamber sensor SE3 and a stroke sensor SE4 are electrically connected to the braking control device 23. Furthermore, as shown in FIG. 1, the vehicle is provided with wheel speed sensors SE5, SE6, SE7, SE8 for each of the wheels FL, FR, RL, RR, and these wheel speed sensors SE5 to SE8 are electrically connected to the braking control device 23. The servo pressure sensor SE2 outputs a signal related to the servo pressure Psv in the servo chamber 39 in the master cylinder 30, and the fluid pressure chamber sensor SE3 outputs a signal related to the fluid pressure in the first fluid pressure chamber 38 in the master cylinder 30. The stroke sensor SE4 outputs a signal related to the amount of operation of the braking operation member 24, and the wheel speed sensors SE5 to SE8 output wheel speed signals related to the wheel speeds of the corresponding wheels FL, FR, RL, RR. In the present description, the wheel speeds of the wheels FL, FR, RL, RR based on the wheel speed signals output from the wheel speed sensors SE5 to SE8 are referred to as “detected value VWS of the wheel speed”.

### <Control Configuration>

As shown in FIG. 1, the driving control device 11 and the braking control device 23 can transmit and receive various types of information with each other. For example, a resolver 10R provided in the driving motor 10 is electrically connected to the driving control device 11. Then, the driving control device 11 calculates motor rotational speed VDM, which is the rotational speed of the output shaft of driving motor 10, based on the output signal from resolver 10R, and transmits the motor rotational speed VDM to the braking control device 23.

As shown in FIG. 1, the braking control device 23 includes a first ECU 231, which is an example of a first control device that controls the operation of the fluid pressure generation device 21, and a second ECU 232, which is an example of a second control device that controls the operation of the braking actuator 22. Note that “ECU” is an abbreviation of “Electronic Control Unit”.

The accumulator pressure detection sensor SE1, the servo pressure sensor SE2, the fluid pressure chamber sensor SE3 and the stroke sensor SE4 are electrically connected to the first ECU 231, while the wheel speed sensors SE5 to SE8 are not electrically connected thereto. Furthermore, the accumulator pressure detection sensor SE1, the servo pressure sensor SE2, the fluid pressure chamber sensor SE3 and the stroke sensor SE4 are not electrically connected to the second ECU 232, while the wheel speed sensors SE5 to SE8 are electrically connected thereto.

Furthermore, the first ECU 231 can communicate with the second ECU 232 and can communicate with the driving control device 11. Therefore, the first ECU 231 can acquire the detected value VWS of the wheel speed of each of the wheels FL, FR, RL, and RR by receiving the wheel speed information transmitted from the second ECU 232. The wheel speed information is information related to the detected values VWS of the wheel speeds of the wheels FL, FR, RL, RR. Furthermore, the first ECU 231 can acquire the motor rotational speed VDM of the driving motor 10 through communication with the driving control device 11.

Furthermore, the vehicle includes an automatic driving control device 90 for causing the vehicle to travel automatically. The automatic driving control device 90 can communicate with the driving control device 11 and the braking control device 23. When the driver of the vehicle sets the automatic traveling mode, the automatic driving control device 90 transmits the required acceleration and the like for the vehicle to the driving control device 11, and transmits the required deceleration and the like for the vehicle to the braking control device 23. When the driving control device 11 receives the required acceleration, the driving control device 11 controls the drive of the driving motor 10 to bring the vehicle body acceleration of the vehicle closer to the required acceleration. Furthermore, when the braking control device 23 receives the required deceleration, the braking control device 23 controls the braking force (=friction braking force BPP+regenerative braking force BPR) on the vehicle so as to bring the vehicle body deceleration of the vehicle closer to the required deceleration.

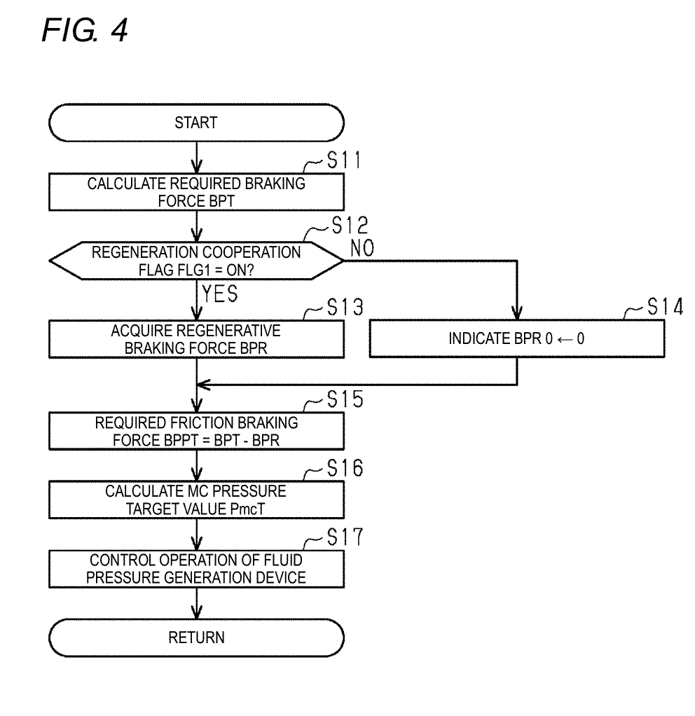

Next, a processing routine executed by the first ECU 231 to control the vehicle deceleration of the vehicle in cooperation with the regenerative device will be described with reference to FIG. 4. This processing routine is executed in each control cycle which is preset when decelerating the vehicle. On the other hand, the processing routine is not executed when the suppression control (first slip suppression control to be described later) for controlling the operation of the fluid pressure generation device 21 and suppressing the slip of the wheel is performed.

As shown in FIG. 4, in the processing routine, the first ECU 231 calculates the required braking force BPT (step S11). When the vehicle is traveling in the manual traveling mode, which is a traveling mode for causing the vehicle to travel by the driver's accelerator operation or braking operation, the first ECU 231 calculates the required braking force BPT based on the operation amount of the braking operation member 24 detected by the stroke sensor SE4. When the vehicle is traveling in the automatic traveling mode, the first ECU 231 calculates the required braking force BPT based on the required deceleration received from the automatic driving control device 90.

Subsequently, the first ECU 231 determines whether or not a regeneration cooperation flag FLG1 to be described later is set to ON (step S12). The regeneration cooperation flag FLG1 is flag that is set to OFF when the application of the regenerative braking force BPR to the vehicle is prohibited in order to perform braking control such as antilock brake control (hereinafter, also referred to as “ABS control”), and set to ON when the application of the regenerative braking force BPR to the vehicle is not prohibited. When the regeneration cooperation flag FLG1 is set to ON (step S12: YES), the first ECU 231 acquires the latest regenerative braking force BPR received from the driving control device 11 (step S13). Then, the first ECU 231 proceeds the process to step S15 to be described later. When the regeneration cooperation flag FLG1 is set to OFF (step S12: NO), the first ECU 231 transmits to the driving control device 11 an indication to make the regenerative braking force BPR equal to “0” (step S14). Then, the first ECU 231 proceeds the process to the next step S15.

In step S15, the first ECU 231 derives a difference (=BPT−BPR) obtained by subtracting the regenerative braking force BPR from the required braking force BPT as the required friction braking force BPPT. At this time, when the indication to make the regenerative braking force BPR equal to “0” as the regeneration cooperation flag FLG1 is set to OFF is transmitted to the driving control device 11, the required friction braking force BPPT becomes equal to the required braking force BPT.

Then, the first ECU 231 calculates an MC pressure target value PmcT which is a target value for the MC pressure Pmc in each of the master chambers 361, 362 in the master cylinder 30 (step S16). At this time, the MC pressure target value PmcT is set to a value corresponding to the required friction braking force BPPT, and is set to a larger value the larger the required friction braking force BPPT. Subsequently, the first ECU 231 controls the operation of the servo pressure generation device 70 of the fluid pressure generation device 21 so that the MC pressure Pmc in each of the master chambers 361 and 362 in the master cylinder 30 becomes equal to the MC pressure target value PmcT (step S17). Thereafter, the braking control device 23 temporarily ends the present processing routine.

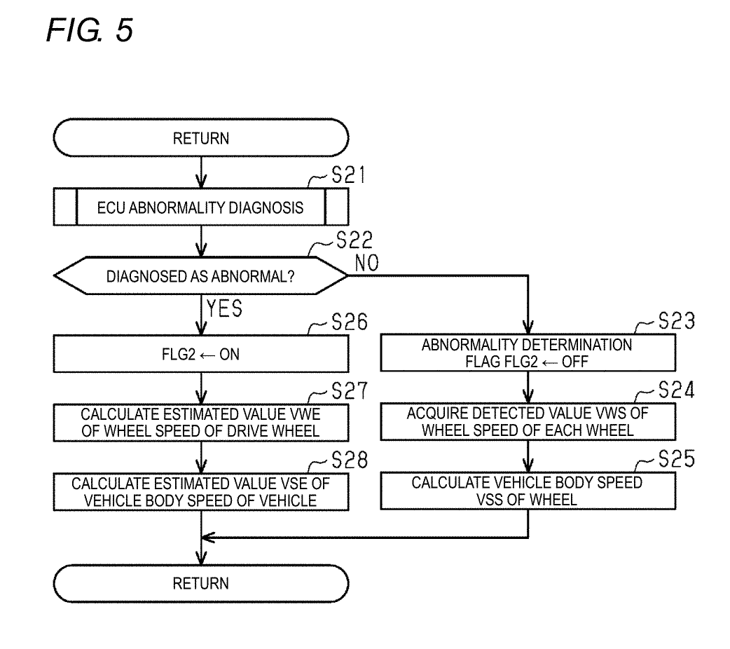

Next, a processing routine executed by the first ECU 231 to diagnose whether or not the second ECU 232 is abnormal and to calculate the wheel speed and the vehicle body speed will be described with reference to FIG. 5. It should be noted that the present processing routine is executed for every control cycle set in advance.

As shown in FIG. 5, in the present processing routine, the first ECU 231 carries out an ECU abnormality diagnosis that diagnoses whether or not the second ECU 232 is abnormal (step S21).

Here, when communication is performed between ECUs, when a signal is transmitted from one ECU to the other ECU, the other ECU replies to the one ECU that the signal from one ECU has been received. Therefore, when one ECU transmits a signal to the other ECU and if a response to the signal is received from the other ECU, determination can be made that the other ECU is operating normally. On the other hand, when one ECU transmits a signal to the other ECU and if a response to the signal cannot be received from the other ECU, determination can be made that an abnormality has occurred in the other ECU.

Thus, in the ECU abnormality diagnosis, when the first ECU 231 transmits a signal to the second ECU 232 and a response to the signal is received from the second ECU 232, diagnosis is made that an abnormality has not occurred in the second ECU 232. On the other hand, when the first ECU 231 transmits a signal to the second ECU 232 and a response to the signal cannot be received from the second ECU 232, diagnosis is made that an abnormality has occurred in the second ECU 232. Therefore, in the present embodiment, an example of an “abnormality diagnosis unit” configured to diagnose whether or not there is an abnormality in the second ECU 232 is configured by the first ECU 231 that executes step S21.

Subsequently, the first ECU 231 determines whether or not the second ECU 232 has been diagnosed as abnormal as a result of the execution of the ECU abnormality diagnosis (step S22). If diagnosis has not been made as abnormal (step S22: NO), the first ECU 231 sets an abnormality determination flag FLG2 to OFF (step S23). The abnormality determination flag FLG2 is a flag that is set to OFF when the second ECU 232 is not diagnosed as abnormal, and is set to ON when the second ECU 232 is diagnosed as abnormal.

Then, the first ECU 231 acquires the detected value VWS of the wheel speed of each of the wheels FL, FR, RL, RR based on the received wheel speed information (step S24). Subsequently, the first ECU 231 calculates the vehicle body speed VSS of the vehicle based on at least one detected value among the acquired detected values VWS of the wheel speeds of the respective wheels FL, FR, RL, RR (step S25). Thereafter, the first ECU 231 temporarily ends the present processing routine.

On the other hand, if diagnosis has been made that the second ECU 232 is abnormal in step S22 (YES), the first ECU 231 sets the abnormality determination flag FLG2 to ON (step S26). In this case, although the first ECU 231 cannot acquire the detected value VWS of the wheel speed, it can acquire the motor rotational speed VDM of the driving motor 10 from the driving control device 11. Therefore, the first ECU 231 can estimate the wheel speed of the wheel (rear wheels RL, RR in the present example) which is drivingly connected to the driving motor 10 among the wheels FL, FR, RL, RR based on the motor rotational speed VDM.

That is, the first ECU 231 calculates the estimated value VWE of the wheel speeds of the rear wheels RL and RR which are drive wheels, using the following relational expression (equation 1) (step S27). The relational expression (equation 1) is an equation when the unit of the motor rotational speed VDM is “rpm” and the unit of the estimated value VWE of the wheel speed is “m/s”. “Gr” in the relational expression (equation 1) is a reduction ratio between driving motor 10 and rear wheels RL and RR, and “R” is a radius of a wheel. In this case, the number of rotations of the wheel per second is calculated by dividing “VDM/Gr” by “60”, and the number of rotations of the wheel is multiplied by the outer circumference “2·π·R” of the wheel, the product of which becomes the estimated value VWE of the wheel speed. The estimated value VWE of the wheel speed calculated in such a manner is a value (e.g., an intermediate value) between the actual wheel speed of the left rear wheel RL and the actual wheel speed of the right rear wheel RR.

VWE=((VDM/Gr)/60)×2·π·R (equation 1)

The first ECU 231 then calculates the estimated value VSE of the vehicle body speed of the vehicle based on the calculated estimated values VWE of the wheel speeds of the rear wheels RL and RR (step S28). Thereafter, the first ECU 231 temporarily ends the present processing routine.

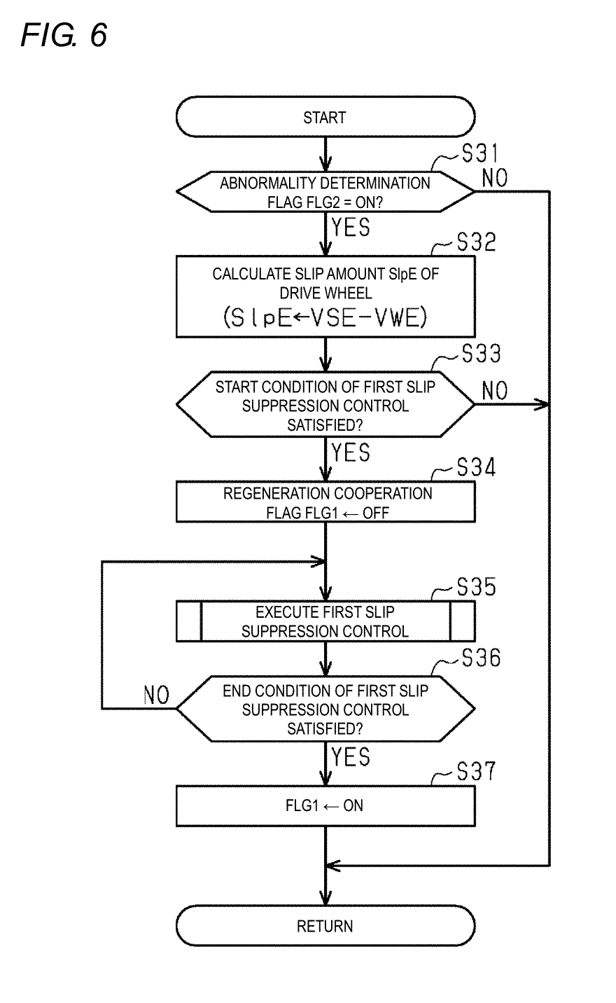

Next, the processing routine executed by the first ECU 231 to control the operation of the fluid pressure generation device 21 when slip is generated at the rear wheels RL, RR and perform a suppression control to suppress the slip will be described with reference to FIG. 6. The execution of the present processing routine is started from the timing a time corresponding to the control cycle has elapsed from the timing the previous execution of the present processing routine ended.

As shown in FIG. 5, in the present processing routine, the first ECU 231 determines whether or not the abnormality determination flag FLG2 is set to ON (step S31). If the abnormality determination flag FLG2 is not set to ON, that is, if the abnormality determination flag FLG2 is set to OFF (step S31: NO), the first ECU 231 temporarily ends the present processing routine. That is, if the abnormality determination flag FLG2 is set to OFF, the second ECU 232 operates the braking actuator 22 to suppress the slip of the wheels FL, FR, RL, and RR, and thus a first slip suppression control, to be described later, is not executed.

On the other hand, if the abnormality determination flag FLG2 is set to ON (step S31: YES), the first ECU 231 calculates the slip amount SlpE of the rear wheels RL, RR which are drive wheels (step S32). At this time, the first ECU 231 sets a difference (=VSE−VWE) obtained by subtracting the estimated value VWE of the wheel speeds of the rear wheels RL and RR from the estimated value VSE of the vehicle body speed as the slip amount SlpE of the rear wheels RL and RR. Then, the first ECU 231 determines whether or not a start condition of first slip suppression control, to be described later, is satisfied (step S33). The start condition of the first slip suppression control includes whether or not the slip amount SlpE of the rear wheels RL and RR is larger than a slip amount determination value. The slip amount determination value is a value for determining whether or not a slip has occurred in at least one of the rear wheels RL and RR.

If the start condition is not satisfied (step S33: NO), the first ECU 231 temporarily ends the present processing routine. On the other hand, if the start condition is satisfied (step S33: YES), the first ECU 231 sets the regeneration cooperation flag FLG1 to OFF (step S34), and performs the first slip suppression control (step S35). The first slip suppression control is one of suppression control for suppressing the slip of the rear wheels RL and RR. That is, in the first slip suppression control, when the regenerative braking force BPR is applied to the rear wheels RL and RR, the first ECU 231 transmits to the driving control device 11 to stop the application of the regenerative braking force BPR to the rear wheels RL and RR. If the slip amount SlpE is still large even if the regenerative braking force BPR on the rear wheels RL and RR becomes equal to “0”, the first ECU 231 controls the operation of the servo pressure generation device 70 to reduce the MC pressure Pmc in each of the master chambers 361, 362. The WC pressure Pwc in all the wheel cylinders 13a to 13d is thereby reduced, so that the friction braking force BPP to apply to each of the wheels FL, FR, RL, RR becomes smaller. When the slip amount SlpE of the rear wheels RL and RR decreases by reducing the braking force applied to the wheels FL, FR, RL, and RR, the first ECU 231 controls the operation of the servo pressure generation device 70 to increase the MC pressure Pmc. The WC pressure Pwc in all the wheel cylinders 13a to 13d is thereby increased, so that the friction braking force BPP applied to each of the wheels FL, FR, RL, and RR becomes larger. That is, in the first slip suppression control, the lowering in the stability of the vehicle behavior is suppressed while decelerating the vehicle by operating the servo pressure generation device 70 to increase or decrease the MC pressure Pmc based on the fluctuation of the slip amount SlpE.

Then, the first ECU 231 determines whether or not the end condition of the first slip suppression control is satisfied (step S36). As an end condition of the first slip suppression control, for example, stop of the vehicle can be mentioned. Furthermore, when execution of the first slip suppression control is started during vehicle braking caused by the driver's braking operation, determination may be made that the end condition is satisfied when the end of the driver's braking operation is detected.

Here, in the present vehicle, the execution of the first slip suppression control may be started at the time of vehicle braking during automatic traveling. Then, when the driver starts the braking operation during the execution of the first slip suppression control, the traveling mode of the vehicle may be switched from the automatic traveling mode to the manual traveling mode. In the present embodiment, the end condition of the execution of the first slip suppression control does not include the switching of the traveling mode of the vehicle from the automatic traveling mode to the manual traveling mode. Therefore, even if the automatic traveling mode is switched to the manual traveling mode during the execution of the first slip suppression control, the execution of the first slip suppression control is continued.

If the end condition is not satisfied in step S36 (NO), the first ECU 231 proceeds the process to step S35 described above, and continues the execution of the first slip suppression control. On the other hand, if the end condition is satisfied (step S36: YES), the first ECU 231 sets the regeneration cooperation flag FLG1 to ON (step S37), and then temporarily ends the present processing routine.

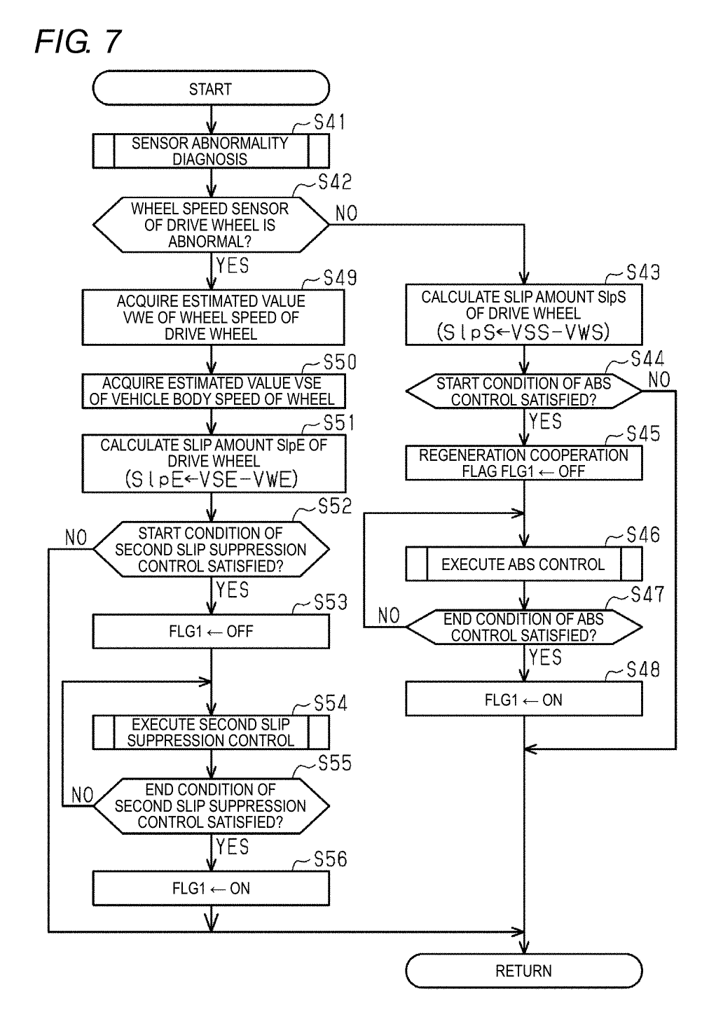

Next, a processing routine executed by the second ECU 232 will be described with reference to FIG. 7. The execution of the present processing routine is started from the timing a time corresponding to the control cycle has elapsed from the timing the previous execution of the present processing routine ended.

As shown in FIG. 7, in the present processing routine, the second ECU 232 performs a sensor abnormality diagnosis for diagnosing whether or not abnormality has occurred in the wheel speed sensors SE7 and SE8 for the rear wheels RL and RR, which are drive wheels drivingly connected to the driving motor 10 (step S41). For example, in the sensor abnormality diagnosis, the second ECU 232 can determine that abnormality has occurred in the wheel speed sensors SE7, SE8 when the detected value VWS of the wheel speeds of the rear wheels RL, RR does not change although the braking force (at least one of the regenerative braking force BPR and the friction braking force BPP) is applied to the rear wheels RL and RR. Therefore, in the present embodiment, the second ECU 232 that performs step S41 configures one example of the “sensor abnormality diagnosis unit” that diagnoses whether or not the wheel speed sensors SE7 and SE8 for the rear wheels RL and RR are abnormal.

Then, as a result of performing the sensor abnormality diagnosis, the second ECU 232 determines whether or not the wheel speed sensors SE7 and SE8 for the rear wheels RL and RR that are drive wheels are abnormal (step S42). When not determined that the wheel speed sensors SE7 and SE8 are abnormal (step S42: NO), whether or not slip, that is, a state in which the wheel speeds of the rear wheels RL and RR are lower than the vehicle body speed has occurred in the rear wheels RL, RR can be determined by using the detected values VWS of the wheel speeds of the rear wheels RL and RR, and thus the second ECU 232 calculates the slip amount SlpS of the rear wheels RL, RR (step S43). At this time, the second ECU 232 can derive a difference (=VSS−VWS) obtained by subtracting the detected values VWS of the wheel speeds of the rear wheels RL and RR from the vehicle body speed VSS of the vehicle as the slip amount SlpS.

Subsequently, the second ECU 232 determines whether or not the start condition of the ABS control on at least one of the rear wheels RL and RR is satisfied (step S44). For example, the second ECU 232 can determine that the start condition of the ABS control is satisfied when the slip amount SlpS of at least one of the rear wheels RL and RR is larger than the slip amount determination value. The slip amount determination value is a value for determining whether or not a slip has occurred in at least one of the rear wheels RL and RR.

If the start condition of the ABS control for any rear wheel among the rear wheels RL and RR is not satisfied (step S44: NO), the second ECU 232 once ends the present processing routine. On the other hand, when the start condition of the ABS control for at least one rear wheel among the rear wheels RL and RR is satisfied (step S44: YES), the second ECU 232 transmits to the first ECU 231 an indication to set the regeneration cooperation flag FLG1 to OFF (step S45). Then, the first ECU 231 that received the indication to set the regeneration cooperation flag FLG1 to OFF sets the regeneration cooperation flag FLG1 to OFF.

Subsequently, the second ECU 232 carries out the ABS control on each rear wheel RL, RR (step S46). The ABS control is one of the suppression controls for suppressing the slip of the rear wheels RL and RR. That is, in the ABS control with respect to the rear wheels RL, RR, when the regenerative braking force BPR is applied to the rear wheels RL and RR, the second ECU 232 transmits to the driving control device 11 to stop the application of the regenerative braking force BPR to the rear wheels RL and RR. If the slip amount SlpS is still large even if the regenerative braking force BPR on the rear wheels RL and RR becomes equal to “0”, the second ECU 232 controls the operation of the braking actuator 22 to reduce the WC pressure Pwc in the wheel cylinders 13c and 13d for the rear wheels RL, RR. The friction braking force BPP to apply to the rear wheels RL and RR thus decreases. When the slip amount SlpS of the rear wheels RL, RR decreases by decreasing the braking force on the wheels FL, FR, RL, RR, the second ECU 232 controls the operation of the braking actuator 22 to increase the WC pressure Pwc in the wheel cylinders 13c and 13d for the rear wheels RL and RR and to increase the friction braking force BPP to apply to the rear wheels RL and RR.

Then, the second ECU 232 determines whether or not the end condition of the ABS control is satisfied (step S47). As the end condition of the ABS control, for example, stop of the vehicle can be mentioned. Furthermore, when execution of the ABS control is started during vehicle braking caused by the driver's braking operation, determination may be made that the end condition is satisfied when the end of the driver's braking operation is detected.

Here, in the present vehicle, execution of the ABS control may be started at the time of deceleration during automatic traveling. When the driver starts the braking operation during the execution of the ABS control, the traveling mode of the vehicle may be switched from the automatic traveling mode to the manual traveling mode. In the present embodiment, the end condition of the execution of the ABS control does not include the switching of the traveling mode of the vehicle from the automatic traveling mode to the manual traveling mode. Therefore, even if the automatic traveling mode is switched to the manual traveling mode during the execution of the ABS control, the execution of the ABS control is continued.

When the end condition is not satisfied in step S47 (NO), the second ECU 232 proceeds the process to step S46 described above, and continues the execution of the ABS control. On the other hand, when the end condition is satisfied (step S47: YES), the second ECU 232 transmits, to the first ECU 231, an indication to set the regeneration cooperation flag FLG1 to ON (step S48), and thereafter, temporarily ends the present processing routine. The first ECU 231 that received the indication to set the regeneration cooperation flag FLG1 to ON sets the regeneration cooperation flag FLG1 to ON.

On the other hand, when determined that the wheel speed sensors SE7 and SE8 for the rear wheels RL and RR are abnormal in step S42 (YES), the second ECU 232 acquires the estimated values VWE of the wheel speeds of the rear wheels RL, RR which are drive wheels from the first ECU 231 (step S49). Subsequently, the second ECU 232 acquires the estimated value VSE of the vehicle body speed of the vehicle from the first ECU 231 (step S50). Then, the second ECU 232 calculates the slip amount SlpE of the rear wheels RL and RR which are drive wheels, as in step S32 described above (step S51). Next, the second ECU 232 determines whether or not a start condition of second slip suppression control to be described later is satisfied (step S52). The start condition of the second slip suppression control is the same as the start condition of the first slip suppression control described above.

When the start condition is not satisfied (step S52: NO), the second ECU 232 temporarily ends the present processing routine. On the other hand, when the start condition is satisfied (step S52: YES), the second ECU 232 transmits, to the first ECU 231, an indication to set the regeneration cooperation flag FLG1 to OFF (step S53). Then, the first ECU 231 that received the indication to set the regeneration cooperation flag FLG1 to OFF sets the regeneration cooperation flag FLG1 to OFF.

Subsequently, the second ECU 232 executes the second slip suppression control (step S54). The second slip suppression control is one of suppression control for suppressing the slip of the rear wheels RL and RR. That is, in the second slip suppression control, when the regenerative braking force BPR is applied to the rear wheels RL and RR, the second ECU 232 transmits to the driving control device 11 to stop the application of the regenerative braking force BPR to the rear wheels RL and RR through the first ECU 231. When the slip amount SlpE is still large even if the regenerative braking force BPR for the rear wheels RL and RR becomes equal to “0”, the second ECU 232 operates the braking actuator 22 to reduce the WC pressure Pwc in the wheel cylinders 13c and 13d for the rear wheels RL, RR. At this time, the second ECU 232 closes the holding valves 83a and 83b for the front wheels FL and FR so that the WC pressure Pwc in the wheel cylinders 13a and 13b for the front wheels FL and FR does not fluctuate. As a result, the friction braking force BPP to apply to the rear wheels RL, RR decreases while suppressing the fluctuation of the friction braking force BPP to apply to the front wheels FL, FR. As described above, when the slip amount SlpE of the rear wheels RL, RR decreases by decreasing the braking force on the rear wheels RL, RR, the second ECU 232 operates the braking actuator 22 to increase the WC pressure Pwc in the wheel cylinders 13c and 13d for the rear wheels RL, RR. As a result, the friction braking force BPP to apply to the rear wheels RL and RR increases. That is, in the second slip suppression control, the lowering in the stability of the vehicle behavior is suppressed while decelerating the vehicle by operating the braking actuator 22 to increase or decrease the WC pressure Pwc in the wheel cylinders 13c, 13d for the rear wheels RL, RR based on the fluctuation of the slip amount SlpE.

Then, the second ECU 232 determines whether or not the end condition of the second slip suppression control is satisfied (step S55). The end condition of the second slip suppression control is the same as the end condition of the first slip suppression control.

Here, in the present vehicle, the execution of the second slip suppression control may be started at the time of deceleration during automatic traveling. Then, when the driver starts the braking operation during the execution of the second slip suppression control, the traveling mode of the vehicle may be switched from the automatic traveling mode to the manual traveling mode. In the present embodiment, the end condition of the execution of the second slip suppression control does not include the switching of the traveling mode of the vehicle from the automatic traveling mode to the manual traveling mode. Therefore, even if the automatic traveling mode is switched to the manual traveling mode during execution of the second slip suppression control, the execution of the second slip suppression control is continued.

If the end condition is not satisfied in step S55 (NO), the second ECU 232 proceeds the process to step S54 described above, and continues the execution of the second slip suppression control. On the other hand, when the end condition is satisfied (step S55: YES), the second ECU 232 transmits, to the first ECU 231, an indication to set the regeneration cooperation flag FLG1 to ON (step S56), and thereafter, temporarily ends the present processing routine. The first ECU 231 that received the indication to set the regeneration cooperation flag FLG1 to ON sets the regeneration cooperation flag FLG1 to ON.

Next, the operation at the time of vehicle braking caused by the application of the braking force of at least one of the regenerative braking force BPR and the friction braking force BPP to the vehicle will be described together with the effect.

When each of the wheel speed sensors SE5 to SE8 is normal and the second ECU 232 controlling the braking actuator 22 is normal, the braking actuator 22 can be operated by the control of the second ECU 232 based on the detected value VWS of the wheel speed. Therefore, whether the slip has occurred in the wheels FL, FR, RL, RR can be determined based on the slip amount SlpS calculated based on the detected value VWS of the wheel speed. Then, when there is a wheel on which a slip has occurred, the ABS control is performed on the relevant wheel.

On the other hand, when an abnormality has occurred in the second ECU 232, the operation of the braking actuator 22 cannot be controlled. The wheel speed sensors SE5 to SE8 are electrically connected to the second ECU 232, but not electrically connected to the first ECU 231. Therefore, in such a case, the first ECU 231 cannot determine whether or not a slip has occurred at the wheels FL, FR, RL, and RR. In this respect, in the present embodiment, the estimated values VWE of the wheel speeds of the rear wheels RL, RR which are drive wheels are calculated in the first ECU 231 based on the motor rotational speed VDM of the driving motor 10 drivingly connected to the rear wheels RL, RR. Then, whether or not a slip has occurred in at least one of the rear wheels RL and RR can be determined based on the estimated values VWE of the wheel speeds of the rear wheels RL, RR. Then, when determination is made that the slip has occurred in at least one rear wheel, the first slip suppression control is performed. As a result, even if the second ECU 232 is abnormal and the operation of the braking actuator 22 cannot be controlled, the slip of the rear wheels RL, RR can be suppressed while decelerating the vehicle by operating the fluid pressure generation device 21.

Furthermore, even when the second ECU 232 is operating normally, an abnormality may occur in the wheel speed sensors SE7, SE8 for the rear wheels RL, RR. Therefore, in the present embodiment, even in such a case, whether or not a slip has occurred in at least one rear wheel of the rear wheels RL, RR can be determined by using the estimated value VWE of the wheel speeds of the rear wheels RL and RR based on the motor rotational speed VDM of the driving motor 10. Then, when determination is made that a slip has occurred in at least one rear wheel, the second slip suppression control is performed. As a result, even when abnormality has occurred in the wheel speed sensors SE7 and SE8 for the rear wheels RL and RR, the slip of the rear wheels RL, RR can be suppressed while decelerating the vehicle by operating the braking actuator 22.

The present vehicle may travel in the automatic traveling mode. At the time of vehicle braking when the traveling mode of the vehicle is the automatic traveling mode, slip may occur on the wheels FL, FR, RL, RR, and at least one suppression control of the ABS control, the first slip suppression control, and the second slip suppression control may be started. The ABS control, the first slip suppression control, and the second slip suppression control are controls for the purpose of suppressing lowering in the stability of the vehicle behavior. Therefore, in the present embodiment, even if the traveling mode is switched from the automatic traveling mode to the manual traveling mode under a situation where at least one of the ABS control, the first slip suppression control, and the second slip suppression control is being performed, the suppression control is performed unless the slip of the wheels FL, FR, RL, RR is not resolved. Therefore, even if the traveling mode is switched from the automatic traveling mode to the manual traveling mode while at least one of the ABS control, the first slip suppression control, and the second slip suppression control is being executed, the lowering in the stability of the vehicle behavior can be suppressed by continuing the execution of the suppression control.

The above embodiment may be modified to another embodiment as described below.
In the embodiment described above, when determined that abnormality has not occurred in the second ECU 232 while abnormality has occurred in the wheel speed sensors SE7, SE8 for the rear wheels RL, RR that are drive wheels, the second ECU 232 adjusts the friction braking force BPP to apply to the rear wheels RL and RR by executing the second slip suppression control for operating the braking actuator 22. However, the present invention is not limited thereto, and when determined that abnormality has not occurred in the second ECU 232 while abnormality has occurred in the wheel speed sensors SE7, SE8 for the rear wheels RL, RR that are drive wheels, the first ECU 231 may be caused to execute the first slip suppression control for operating the fluid pressure generation device 21. Even in this case, the friction braking force BPP to apply to each of the wheels FL, FR, RL, RR can be adjusted by the first slip suppression control, and furthermore, lowering in the stability of the vehicle behavior can be suppressed while decelerating the vehicle.
Although one of the wheel speed sensors SE7 and SE8 for the rear wheels RL and RR is normal, an abnormality may occur in the other of the wheel speed sensors SE7 and SE8. In this case, the detected value VWS of the wheel speed of one rear wheel (e.g., right rear wheel RR) corresponding to one wheel speed sensor of the rear wheels RL and RR can be calculated, and thus whether or not a slip has occurred on one of the rear wheels can be determined using the detected value VWS of the wheel speed of the one rear wheel. Therefore, in such a case, when determined that a slip has occurred on one rear wheel, the second ECU 232 carries out the ABS control on one rear wheel to adjust the friction braking force BPP to apply to the one rear wheel.

Furthermore, in such a case, whether or not a slip has occurred on the other rear wheel can be determined based on the detected value VWS of the wheel speed of one rear wheel and the estimated values VWE of the wheel speeds of the rear wheels RL, RR based on the motor rotational speed VDM. That is, when no slip has occurred on one rear wheel and the other rear wheel, the difference between the detected value VWS of the wheel speed of one rear wheel and the estimated value VWE of the wheel speeds of rear wheels RL and RR is small. On the other hand, when no slip has occurred on one rear wheel and a slip has occurred on the other rear wheel, the estimated value VWE of the wheel speeds of the rear wheels RL and RR is smaller than the detected value VWS of the wheel speed of the rear wheel, and the difference is large. When the slip amount SlpE based on the estimated value VWE of the wheel speeds of the rear wheels RL and RR becomes greater than or equal to the slip determination value under such a situation, the friction braking force BPP to apply to the other rear wheel may be adjusted by the second slip suppression control by the second ECU 232. Moreover, in this case, the control of suppressing the increase of the friction braking force BPP to apply to one rear wheel (i.e., yaw control control) by the operation of the braking actuator 22 is performed to suppress the lowering in the stability of the vehicle behavior while suppressing the decrease in the deceleration of the vehicle.
In the embodiment described above, the second ECU 232 does not directly communicate with the driving control device 11. Therefore, the second ECU 232 acquires the motor rotational speed VDM through the first ECU 231. However, the second ECU 232 and the driving control device 11 may directly communicate with each other. In this case, the second ECU 232 can obtain the motor rotational speed VDM directly from the driving control device 11 without the intervention of the first ECU 231.
In the above embodiment, the first ECU 231 directly communicates with the driving control device 11 and acquires the motor rotational speed VDM as rotational speed information of the power generator, but may acquire the rotational speed information of the power generator through other methods. For example, the first ECU 231 may be caused to acquire the rotational speed information of the power generator through a data bus shared by a plurality of ECUs including the respective ECUs 231 and 232, the second ECU 232 or other ECUs not shown, and the like. Further, a method of transmitting the rotational speed information of the power generator to the first ECU 231 may be a method of transmitting the rotational speed information not by communication but by an analog signal (such as a voltage) or a pulse signal. However, when the first ECU 231 acquires both the rotational speed information of the power generator and the wheel speed information through the second ECU 232, the first ECU 231 may not be able to acquire both the rotational speed information of the power generator and the wheel speed information at the time of abnormality of the second ECU 232.
The rotational speed information of the power generator may be information other than the motor rotational speed VDM, as long as the information changes in conjunction with the rotational speed of the power generator. Furthermore, when the driving control device 11 calculates the estimated value of the wheel speed based on the rotational speed information of the power generator, the first ECU 231 may be caused to acquire the estimated value of the wheel speed calculated by the driving control device 11 as rotational speed information of the power generator.
The wheel speed sensors SE5 to SE8 may be electrically connected to the first ECU 231. Even in this case, when the wheel speed sensors SE7 and SE8 for the rear wheels RL and RR are diagnosed as abnormal, the first ECU 231 can use the estimated value VWE of the wheel speeds based on the rotational speed information of the power generator to perform the first slip suppression control.
The first ECU 231 may be able to acquire information from the longitudinal acceleration sensor and the camera of the vehicle. In this case, the first ECU 231 can calculate the estimated value VSE of the vehicle body speed of the vehicle using information from the longitudinal acceleration sensor and the camera based on the calculated estimated value VWE of the wheel speeds of the rear wheels RL and RR.
The second ECU 232 transmits, to the first ECU 231, the wheel speed information related to the detected values VWS of the wheel speeds of the wheels FL, FR, RL, RR calculated by itself. That is, the first ECU 231 acquires the detected value VWS of the wheel speed of each of the wheels FL, FR, RL, RR calculated by the second ECU 232. However, when the first ECU 231 makes a diagnosis that there is an abnormality in the wheel speed information transmitted by the second ECU 232, the first ECU 231 may acquire the estimated value VWE of the wheel speeds of the rear wheels RL and RR, and perform the first slip suppression control when determination can be made that a slip has occurred on the rear wheels RL and RR. In such a case, even if no abnormality has occurred in the second ECU 232, the second ECU 232 does not execute the ABS control or the second slip suppression control.
The braking control device 23 may be configured to control both the operation of the fluid pressure generation device 21 and the operation of the braking actuator 22 with one ECU. In this case, when an abnormality has occurred in the wheel speed sensors SE7 and SE8 for the rear wheels RL and RR, the estimated value VWE of the wheel speeds of the rear wheels RL and RR based on the motor rotational speed VDM is used to determine whether or not a slip has occurred in at least one of the rear wheels RL, RR, and the friction braking force BPP to apply to the rear wheels RL, RR may be adjusted when determined that there is a rear wheel in which slip has occurred. In this case, the fluid pressure generation device 21 may be operated by the first slip suppression control, or the braking actuator 22 may be operated by the second slip suppression control.

As described above, in the case where one ECU controls both the operation of the fluid pressure generation device 21 and the operation of the braking actuator 22, the fluid pressure generation device may have a configuration in which the operating unit is not provided as long as it has a master piston in which the master piston is moved in accordance with the driver's braking operation to increase the MC pressure in the master chamber.
A control for operating the friction braking device 20 using the wheel speed includes, for example, a traction control that suppresses slippage of a wheel. When a diagnosis is made that the wheel speed sensors SE7 and SE8 for the rear wheels RL and RR are abnormal under a situation where the second ECU 232 is not abnormal, the slippage of the rear wheels RL, RR can be suppressed by operating the braking actuator 22 based on the estimated value VWE of the wheel speeds of the rear wheels RL, RR.
If the fluid pressure generation device includes an operating unit capable of adjusting the MC pressure Pmc in the master chamber regardless of the driver's braking operation, the fluid pressure generation device may be a device having other configurations other than the fluid pressure generation device 21 described in the above embodiments. For example, the fluid pressure generation device may be a device that includes an electric motor, a conversion unit that converts rotational movement of an output shaft of the electric motor into linear movement, and a piston that moves forward and backward by the driving force of the electric motor input through the conversion unit, and that can adjust the MC pressure Pmc in the master chamber by the movement of the piston.
The friction braking device may not use the brake fluid as long as it can apply friction braking force BPP to the wheels FL, FR, RL, RR by operating the brake mechanism provided for the wheels FL, FR, RL, RR. For example, the friction braking device may be an electric braking device in which a braking motor is provided for each of the wheels FL, FR, RL, and RR.
If the regenerative device can apply regenerative braking force to at least one wheel, it may include a power generator different from a motor that can function as a driving source of the vehicle at the time of vehicle traveling.
The vehicle including the friction braking device 20 may be capable of applying the regenerative braking force BPR to the front wheels FL, FR while applying no regenerative braking force BPR to the rear wheels RL, RR. Furthermore, if the vehicle including the friction braking device 20 can apply the regenerative braking force BPR to at least one of the front wheels FL and FR and the rear wheels RL and RR, the vehicle may be a hybrid vehicle including not only the driving motor 10 but also and engine as a driving source of the vehicle.

1. A vehicle braking system comprising:
a regenerative device that applies a regenerative braking force to a wheel;
a friction braking device operable to apply friction braking force to the wheel; and
a control device that controls the regenerative device and the friction braking device based on a required braking force that is a braking force to be applied to a vehicle,
a wheel speed sensor that outputs a wheel speed signal related to a rotational speed of the wheel being electrically connected to the control device,
wherein the control device
adjusts the friction braking force to be applied to the wheel by operating the friction braking device based on a detected value of the wheel speed when a detected value of the wheel speed based on the wheel speed signal is acquirable, and
adjusts the friction braking force to be applied to the wheel by acquiring an estimated value of a wheel speed of the wheel based on a rotational speed of a power generator of the regenerative device, and operating the friction braking device based on the estimated value of the wheel speed when the detected value of the wheel speed based on the wheel speed signal is not acquirable.

2. The vehicle braking system according to claim 1, wherein
the control device includes a first control device that communicates with the regenerative device, and a second control device that communicates with the first control device;
the wheel speed sensor is electrically connected to the second control device, but is not electrically connected to the first control device;
the first control device includes an diagnose an abnormality diagnosis unit that makes a diagnosis on whether or not there is an abnormality in the second control device or wheel speed information related to the detected value of the wheel speed of the wheel transmitted from the second control device; and
under a situation where diagnosis is made by the abnormality diagnosis unit that there is abnormality in the second control device or the wheel speed information, the first control device operates the friction braking device based on the estimated value of the wheel speed of the wheel to adjust the friction braking force to be applied to the wheel.

3. The vehicle braking system according to claim 2, wherein
the friction braking device increases the friction braking force to be applied to the wheel by increasing a fluid pressure in a wheel cylinder provided for the wheel; and
the friction braking device includes:
a fluid pressure generation device including an operating unit for operating a master piston to generate a fluid pressure in a master chamber connected to the wheel cylinder; and
a braking actuator provided separately from the fluid pressure generation device and configured to adjust the fluid pressure in the wheel cylinder by a control of the second control device.

4. The vehicle braking system according to claim 2, wherein
the second control device includes a sensor abnormality diagnosis unit that diagnoses whether or not the wheel speed sensor is abnormal, and
when diagnosis made by the sensor abnormality diagnosis unit that the wheel speed sensor is abnormal, the friction braking device is operated based on the estimated value of the wheel speed of the wheel to adjust the friction braking force to be applied to the wheel.

5. The vehicle braking system according to claim 1, wherein
a control of the friction braking device based on the detected value of the wheel speed of the wheel or the estimated value of the wheel speed of the wheel includes a suppression control for suppressing a slip of the wheel, and
the control device continues the suppression control even if a traveling mode of the vehicle is switched from an automatic traveling mode to a manual traveling mode when execution of the suppression control is started during vehicle traveling in the automatic traveling mode.

6. The vehicle braking system according to claim 3, wherein
the second control device includes a sensor abnormality diagnosis unit that diagnoses whether or not the wheel speed sensor is abnormal, and
when diagnosis made by the sensor abnormality diagnosis unit that the wheel speed sensor is abnormal, the friction braking device is operated based on the estimated value of the wheel speed of the wheel to adjust the friction braking force to be applied to the wheel.

7. The vehicle braking system according to claim 2, wherein
a control of the friction braking device based on the detected value of the wheel speed of the wheel or the estimated value of the wheel speed of the wheel includes a suppression control for suppressing a slip of the wheel, and
the control device continues the suppression control even if a traveling mode of the vehicle is switched from an automatic traveling mode to a manual traveling mode when execution of the suppression control is started during vehicle traveling in the automatic traveling mode.

8. The vehicle braking system according to claim 3, wherein
a control of the friction braking device based on the detected value of the wheel speed of the wheel or the estimated value of the wheel speed of the wheel includes a suppression control for suppressing a slip of the wheel, and
the control device continues the suppression control even if a traveling mode of the vehicle is switched from an automatic traveling mode to a manual traveling mode when execution of the suppression control is started during vehicle traveling in the automatic traveling mode.

9. The vehicle braking system according to claim 4, wherein
a control of the friction braking device based on the detected value of the wheel speed of the wheel or the estimated value of the wheel speed of the wheel includes a suppression control for suppressing a slip of the wheel, and
the control device continues the suppression control even if a traveling mode of the vehicle is switched from an automatic traveling mode to a manual traveling mode when execution of the suppression control is started during vehicle traveling in the automatic traveling mode.

10. The vehicle braking system according to claim 6, wherein
a control of the friction braking device based on the detected value of the wheel speed of the wheel or the estimated value of the wheel speed of the wheel includes a suppression control for suppressing a slip of the wheel, and
the control device continues the suppression control even if a traveling mode of the vehicle is switched from an automatic traveling mode to a manual traveling mode when execution of the suppression control is started during vehicle traveling in the automatic traveling mode.
